(19) United States
(12) Patent Application Publication
(10) Pub. No.: US 2003/0041012 A1
(43) Pub. Date: Feb. 27, 2003

(54) System and method for establishing customized financing terms

(76) Inventors: William Grey, Millwood, NY (US); Stuart I. Feldman, Stamford, CT (US); Dailun H. Shi, Croton on Hudson, NY (US); Frederick Yung-Fung Wu, Cos Cob, CT (US); Brian T. Eck, Poughquag, NY (US); Brenda L. Dietrich, Yorktown Heights, NY (US)

Correspondence Address: BUCKLEY, MASCHOFF, TALWALKAR, & ALLISON, 5 ELM STREET, NEW CANAAN, CT, 06840, US

(21) Appl. No.: 09/935,248

(22) Filed: Aug. 22, 2001

(51) Int. Cl. G06F 17/60

(52) U.S. Cl. 705/37

(57) ABSTRACT

A system, method, apparatus, and computer program code for establishing customized financing terms includes identifying a bid for an item, identifying a financing function associated with a participant, and applying the financing function to the bid to generate a transformed bid reflecting customized financing terms.

### CROSS-REFERENCE TO RELATED APPLICATIONS

This application is related to the following co-pending and commonly assigned U.S. patent applications (the content of each of which is hereby incorporated by reference herein for all purposes):

U.S. patent application Ser. No. ______, filed ______ (on even date herewith) for “SYSTEM AND METHOD FOR PERSONALIZED DYNAMIC PRICING” (Attorney Docket No. I01.50 and Client Docket No. YOR920010388US1);

U.S. patent application Ser. No. ______, filed ______ (on even date herewith) for “SYSTEM AND METHOD FOR CONDUCTING A SELL-SIDE AUCTION” (Attorney Docket No.I 01.51 and Client Docket No. YOR920010409US1);

U.S. patent application Ser. No. ______, filed ______ (on even date herewith) for “SYSTEM AND METHOD FOR CONDUCTING A BUY-SIDE AUCTION” (Attorney Docket No. I01.52 and Client Docket No. YOR920010410US1);

U.S. patent application Ser. No. ______, filed ______ (on even date herewith) for “SYSTEM AND METHOD FOR CONDUCTING A TWO-SIDED AUCTION” (Attorney Docket No. I01.53 and Client Docket No. YOR920010411US1);

U.S. patent application Ser. No. ______, filed ______ (on even date herewith) for “SYSTEM AND METHOD FOR FACILITATING TRANSACTIONS AMONG DISPARATE ENTITIES” (Attorney Docket No. I01.55 and Client Docket No. YOR920010413US1); and

U.S. patent application Ser. No. ______, filed ______ (on even date herewith) for “SYSTEM AND METHOD FOR CONFIGURING GOODS” (Attorney Docket No. I01.56 and Client Docket No. YOR920010414US1).

### FIELD OF THE INVENTION

The present invention generally relates to commerce systems and methods. More particularly, embodiments of the present invention relate to systems and methods for conducting sales of goods and services.

### BACKGROUND OF THE INVENTION

Auctions have proliferated with the advent of the Internet and advances in communication. Many businesses use auctions and marketplaces to buy and sell goods and services and often enjoy great savings and efficiencies as a result. The essential premise of an auction is that prices are determined as a result of competition between bidders for items offered for sale or purchase. These benefits, however, are only realized when more than one bidder is competing for the same item.

A number of different auctions styles and types have developed over the years to encourage different types of competitions among bidders, including, for example: English auctions, Dutch auctions, Japanese auctions, sealed-bid auctions, double auctions, multiple-unit auction, time interval auctions, call auctions, first price auctions, uniform second price auctions, bundle auctions, and multi-attribute auctions.

Many of these types of auctions may be conducted as either one or two-sided auctions. One-sided auctions allow only bids or asks (but not both). One-sided auctions may be run as open or sealed-bid auctions, and as forward or reverse auctions. Two-sided (or double) auctions allow both bids and asks to take place at the same time. The term auction as defined herein shall also include exchanges, which are electronic or online marketplaces that facilitate a many-to-many trading relationship among or between buyers and sellers. Exchanges are commonly referred to by a number of names, including a trading hub, a vortex, an online marketplace, butterfly market, a bid-ask, an e-marketplace, an e-market, an ehub, a net market maker, an eMarket, a vertical marketplace, or a horizontal marketplace. The term auction as defined herein shall also include bulletin boards and other online commerce platforms that facilitate or enable one-to-many or many-to-many trading relationships among or between buyers and sellers. These various types of auctions and marketplaces are generally known in the art.

One type of two-sided auction is the “continuous double auction” where many individual transactions are carried on simultaneously and where trading does not stop when a match occurs. Examples of such auctions are financial or securities exchanges such as intra-day trading on the New York Stock Exchange. Another type of two-sided auction is a call auction, where bids and offers are aggregated, then periodically cleared. Examples of such auctions are the opens at the New York Stock Exchange and periodic calls on the Paris Bourse.

Some auctions and marketplaces are completely automated. In other cases, non-automated entities facilitate, support or otherwise enable marketplace transactions, potentially providing a number of benefits, including increasing market liquidity, and ensuring orderly price movements. For example, “specialists” serve this role on the New York Stock Exchange, and market-makers serve this role on the NASDAQ. As defined herein, auctions include both purely automated marketplaces, and marketplaces in which non-automated entities facilitate, support or otherwise enable marketplace transactions.

A common feature of most of these auctions and marketplaces is that they are generally used to sell or acquire relatively homogeneous goods or services. Without standardization of the goods or services, it is difficult to generate sufficient competition among bidders to achieve the benefits that auctions provide. As a result, auctions are typically not suited for many types of non-standardized goods or services.

Further, auctions are typically not suited for many types of business-to-business environments. Many business-to-business transactions rely on existing relationships between the buyer and the seller. For example, sellers often provide strategic partner discounts to buyers with whom they have a long-standing relationship. Strategic customers expect, and often receive, volume discounts, preferred credit terms, and higher service levels than other customers. Channel partners expect to pay lower prices than their customers. Most existing auctions do not encourage or permit this type of differentiation between participants. Most existing auctions treat all participants as equals. Buyers who purchase in volume pay the same price as buyers who purchase in smaller lots. In fact, buyers who purchase in volume may sometimes pay more than buyers who purchase in smaller lots, since purchases by large buyers may have an impact on the market price of the good or service being transacted, since the size of these purchases results in an imbalance between supply and demand in the market, and may be viewed as a signal regarding future price movements.

Typically, existing auctions treat the bids of strategic, or long-standing customers or suppliers the same as bids from brand new customers or suppliers. It would be desirable to provide an auction and exchange system and method that allows participants to be treated differently, while still allowing these different participants to take part in the same auction.

Existing auctions are also not well-suited to the sale of differentiated or mass-customized products. Such products are often bundled with value-added services or contain a variety of special features and configurations. Items offered for sale or purchase using existing auctions are not typically customizable. Bidders all bid on the same configuration. As a result, because of their specialized nature, items sold at existing auctions may not attract enough interested bidders to generate active bidding. Many buyers and sellers in existing auctions attempt to minimize this problem by compromising and offering standard product configurations. These standard configurations lack differentiation and often sell at lower, commodity prices. Low commodity pricing can lead to price erosion in other channels and for other products, as customers and channel partners in other sales channels begin demanding comparable pricing.

A number of auction mechanisms have attempted to address some of these shortcomings. Multi-attribute auctions and exchanges allow bidders to negotiate over the attributes of an item, as well as its price, thus seeking to address the issue of auctioning differentiated goods and services. However, determining the winner of a multi-attribute auction often requires complex analysis, and is not readily transparent to market participants. This makes it difficult for auction participants to understand the bidding process, and may raise concerns about whether the auction is matching bids and offers in an equitable fashion. In addition, multi-attribute auctions often require bidders to specify the relative value they place on different attributes. In many cases, bidders may not know clearly the relative value they place on different attributes, or may have difficulty specifying it. This also creates difficulties for another reason. In many cases it may not be in the bidders' interest to be completely forthcoming about this information, and thus they may withhold or misrepresent this information. Unfortunately, these misrepresentations can distort the auction results.

Combinatorial auctions and combinatorial exchanges allow bidders to negotiate for bundles of items. Typically, bidders specify the relative importance they place on different bundles of items, and the auction performs an optimization to match bids and offers in a fashion that maximizes the benefit to market participants. Unfortunately, combinatorial auctions and exchanges may suffer from similar drawbacks as multi-attribute auctions. They are complex, making it difficult for auction participants to understand and interpret the bidding process and auction results. In addition, they may require bidders to reveal information that they consider private, and may thus be subject to misrepresentations by auction participants.

It would be desirable to provide a system and method that facilitates customization and product differentiation in auction environments, without introducing the complexities, information distortions, and uncertainties of multi-attribute and combinatorial auctions and exchanges. Preferably, the system and method would permit different participants to competitively bid on customizable products and services in a manner that is flexible, yet straightforward. Further, it would be desirable to provide a system and method that allows participants to competitively bid on equitable terms, despite different treatment for different participants.

Frequently, participants in auctions wish to acquire goods or services offered in the auction by financing the purchase or acquisition of the goods or services. Different buyers may have different financing preferences. Similarly, different sellers may have different types of financing that they wish to extend. For example, in an auction of computer equipment, one prospective buyer may wish to purchase the equipment outright, while another prospective buyer may wish to lease the computer equipment. One buyer may wish to lease the computer equipment over a short period, while another buyer may wish to lease the equipment over a long period. One seller may wish to extend buyers a lease using a market interest rate, while another seller may want to stimulate demand by extending buyers a lease using a below-market interest rate. Further, one buyer may be a better credit risk than another buyer (e.g., may have a better credit rating). In existing auctions, the establishment of financing terms is typically performed at the end of the auction when a successful bidder is identified. Even if financing terms are established prior to the end of the auction, it may still be difficult for bidders to assess the financial implications of a bid on the magnitude of the associated lease or loan payment.

It would be desirable to provide a system and method which allows the establishment of customized financing terms prior to or during the conduct of the auction. Preferably, the establishment of customized financing terms occurs in a manner that allows different participants to establish different financing terms while still participating in the same auction. Preferably, the establishment of customized financing terms occurs in a manner that allows different financial services providers to offer different loan and leasing terms to auction participants.

It would also be desirable to allow some participants in the auction to finance or lease auction items, while allowing other participants to purchase the item outright. It would further be desirable to provide a system and method which allows a participant to view the current status of an auction by transforming the status to present the status based on the financing terms established for the participant.

### SUMMARY OF THE INVENTION

Embodiments of the present invention provide a system, method, apparatus, and computer program code for establishing customized financing terms.

According to one embodiment of the present invention, a system, method, apparatus, and computer program code for establishing customized financing terms includes identifying a bid for an item, identifying a financing function associated with a participant, and applying the financing function to the bid to generate a transformed bid reflecting customized financing terms.

According to one embodiment, the financing function includes at least a first parameter identifying a type of financing instrument, such as a lease or a loan. According to one embodiment, the financing function includes at least a first financing term. In some embodiments, the at least first financing term may identify at least one of: the frequency of payments of the financing instruments; the number of payments associated with the financing instrument; the timing of payments associated with the financing instrument (e.g. whether payments occur at the beginning of the period, the end of the period, or at some point in between); a duration of the financing instrument; an interest rate of the financing instrument; a collateral requirement, a penalty structure for late payments, and a down payment required for the financing instrument.

According to one embodiment, identifying a financing function further includes receiving a request to establish a financing function from the participant, identifying a type of the financing function, identifying at least a first term of the financing function, and associating the financing function with the participant. According to another embodiment, identifying a financing function includes searching through a plurality of pre-established financing functions. According to another embodiment, identifying a financing function includes interacting with a provider of loans or leases to identify potential loan or lease terms, and associating the financing function with the participant.

According to one embodiment, a system, method, apparatus, and computer program code for conducting an auction includes first receiving a bid, then identifying an item and an auction based at least in part on the bid. At least a first customized financing term associated with said bid is identified and a status of the auction is updated to reflect the bid and the at least first customized financing term. A determination is made if the bid is a winning bid of the auction, and the auction is settled based on the at least first customized financing term. In some embodiments, the determination is made by comparing two bids having different customized financing terms to determine which bid is the winning bid of the auction.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a block diagram of a system pursuant to embodiments of the present invention;

FIG. 2 is a block diagram of one embodiment of the auction administrator device of FIG. 1;

FIG. 3 is a tabular representation of a portion of a participant database according to an embodiment of the present invention;

FIG. 4 is a tabular representation of a portion of an auction database according to an embodiment of the present invention;

FIG. 5 is a tabular representation of a portion of a financing database according to an embodiment of the present invention;

FIG. 6 is a tabular representation of a portion of a bid database according to an embodiment of the present invention;

FIG. 7 is a flow diagram depicting a process for establishing customized financing terms according to one embodiment of the present invention; and

FIG. 8 is a flow diagram depicting a transaction process according to one embodiment of the present invention.

### DETAILED DESCRIPTION

Applicants have recognized that there is a need for a system, method, apparatus, and computer program code for establishing personalized financing terms for auctions or exchanges. In particular, Applicants have recognized that the ability to establish and use customized financing terms to transform bids and auction status to personalize the auction experience for multiple differently-situated participants will facilitate competitive bidding between these participants, resulting in overall reduced prices for buyers, and increased demand for sellers. Further, because participants can now customize their participation, they will be more likely to increase their frequency of use of auctions as a means of buying and selling items.

A number of terms are used herein to describe features of embodiments of the present invention. As used herein, the term “auction” will be used to refer to any of a number of formats (known and to be developed) for selling goods or services in a competitive bidding environment. As used herein, the term “auction” may be used to refer to the set of activities that take place to solicit, receive, analyze, and respond to bids for a particular item or items. A number of different auctions may take place at any given time. Each auction involves the interaction of several entities, including at least one buyer, at least one seller, and an auction administrator. In some embodiments, one or more service providers may be involved in an auction, acting on behalf of one or more buyers, sellers, and/or administrators.

As will be described, embodiments of the present invention may be used with a number of different types of auctions, including, for example, those auctions referred to as: English auctions, Dutch auctions, Japanese auctions, sealed-bid auctions, double auctions, multiple-unit auctions, time interval auctions, call auctions, first price auctions, uniform second price auctions, bundle auctions, combinatorial auctions, and multi-attribute auctions. Embodiments of the present invention may also be used with other types of exchanges and marketplaces known in the art.

As used herein, the term “bid” (or the term “submission”) will be used to refer to an offer to purchase or an offer to sell (depending on the type of auction in which the bid is made) received from an auction participant. For the purposes of this disclosure, the term “bidder” will be used to refer to the party submitting a bid. A buyer or a seller (both of which are defined further below) may be a bidder, depending on the type of auction. A bid may include one or more terms of the bid, such as a price term, a quantity term, a configuration term, a delivery term, or the like. The bid may involve an actual purchase or transfer, a contingent purchase or transfer, the purchase or transfer of certain rights, and other types of commercial and non-commercial transactions known in the art.

As used herein, the term “buyer” may be used to refer to a party submitting a bid (an offer to purchase) on an item in an auction. For example, the buyer may be a prospective buyer, submitting an offer to purchase or acquire an item offered in an auction. For the purposes of this disclosure, the term “buyer” refers to prospective buyers as well as the actual purchasers of item(s) by auction. A buyer could also be a human agent representing a prospective buyer, or an intelligent software agent such as a shopping “bot” representing a prospective buyer.

As used herein, the term “seller” may be used to refer to the party offering to sell or provide an item in an auction. For example, the seller may be a prospective seller, submitting a bid (an offer to sell or distribute) on an item offered in an auction. For the purposes of this disclosure, the term “seller” refers to prospective sellers as well as the actual seller of item(s) by auction. A seller could also be a human agent representing a prospective seller, or an intelligent software agent such as a shopping “bot” representing a prospective seller. Both “buyers” and “sellers” will be referred to as “participants” in the auction.

As used herein, the phrase “winning bid” will be used to refer to the bid (either an offer to purchase, an offer to sell, or either an offer to sell or an offer to purchase, depending on the type of auction) which, at the close of the auction, results in the winning participant acquiring the right (or obligation) to purchase or sell the item offered in the auction. Depending on the type of auction, the “winning bid” may not necessarily be the highest priced bid (e.g., in a Dutch auction, the winning bid may be at a lower price than earlier bids). Depending on the type of the auction, there may be multiple “winning bids”. As used herein, the phrase “current best bid” will be used to refer to any bid which, during the conduct of the auction, would be the “winning bid” if the auction were to close without consideration of further bids.

As used herein, the term “administrator” will be used to refer to an entity operating as the coordinator, organizer or facilitator of an auction or exchange. The administrator may be an independent entity operating a commercial auction or exchange, or the administrator may be operating on behalf of a seller or buyer to conduct a closed or private auction with a limited number of participants. The administrator may also be operating on behalf of a seller or buyer to conduct a public auction with a broad range of participants. In embodiments described herein, the administrator will be described as the entity controlling the resources used to solicit information (e.g., bids, auction status data, and transformation data). In some embodiments, the administrator may be an independent entity. In other embodiments, the administrator may be an affiliate of one or more participants in the auction, and/or an affiliate of one or more service providers. In other embodiments, the administrator may be a participant in the auction, or a service provider, or an entity partially or entirely owned or controlled by one or more participants in the auction, or by one or more service providers.

As used herein, the term “service provider” will be used to refer to an entity that provides value-added services such as logistics support, fulfillment, financing, or transaction settlement services that facilitate conducting transactions in an auction or exchange. The service provider may be an independent entity providing services, an entity operating on behalf of an auction administrator, or an entity operating on behalf of a participant (e.g., a buyer or seller) in an auction. In some embodiments, the service provider may be an entity controlling resources used to solicit information (e.g., information used to develop financing functions or other information used in conjunction with embodiments of the present invention).

In particular, service providers could include providers of credit, providers of credit insurance, providers of credit enhancement, providers of credit scores, providers of credit information, providers of market information about interest rates, providers of information about the credit-worthiness of participants in a financing arrangement, brokers, providers of insurance for assets that are used to secure financing arrangements, appraisers of assets that are used to secure financing arrangements, providers of information about expected residual values of assets that are included in financing arrangements, providers of market values of assets that are included in financing arrangements, providers of information about competitive financing terms being offered in the marketplace, providers of derivative securities, application service providers, providers of credit settlement services, providers of payment settlement services, providers of trade financing, providers of import-export financing, and banks and other financial services institutions and organizations.

As used herein, the term “item” may be used to refer to any of a number of different types of goods or services that may be purchased or sold in an auction or exchange format. As an illustrative example, items that may be purchased or sold using techniques of the present invention may include: differentiated goods, commodities, factor inputs, components, systems, subsystems, devices, raw materials, manufactured products, services, options to purchase goods or services, financial instruments, claims on assets, contingent claims on assets, or the like. An “item” may be an individual component, device or service. An “item” may also be a grouping of individual components, devices or services (sometimes referred to herein and in the art as a “lot” or as a “bundle”). An “item” may also be an assemblage of components and/or services into a system (sometimes referred to herein and in the art as a “configuration”).

As used herein, the term “financing instrument” may be used to refer to any of a number of contracts or other instruments used to fund or finance a purchase, lease or other use of one or more items acquired via an auction operated pursuant to embodiments of the present invention. A financing instrument may be a loan, mortgage or other contract to purchase, or a lease or other contract to rent or lease one or more items acquired via an auction operated pursuant to embodiments of the present invention.

Each of these different types of financing instruments may include one or more “financing terms” such as: a financing price; fees or other charges associated with the financing instrument (e.g. origination fees, maintenance fees, prepayment fees, late fees, etc.); a term or duration of the financing instrument; a residual value; a fixed interest rate associated with a financing instrument; a benchmark rate associated with a floating rate financing instrument; spreads with reference to a benchmark rate associated with a floating rate financing instrument; options such as interest rate derivatives such as caps and floors that affect the cash flows of the financing instrument; specifications of options to extend or to terminate the financing instrument; a residual or terminal value of said financing instrument; an option to buy an item being financed; an option to sell an item being financed; terms and conditions associated with the state of the item being financed (e.g. penalties for excess usage, or requirements that an item serving as collateral for a loan be maintained in a certain condition); terms and conditions associated with the use of the item (e.g. requirements that certain types of insurance be maintained during the course of a lease or loan; requirements that an asset be used in a certain manner or for a certain purpose, requirements that certain types of maintenance be performed; or requirements that an item not be operated in a certain manner); terms and conditions associated with one or more parties to the financing arrangements (such as debt covenants limiting issuance of other debt or requirements that a lessor maintain a certain level of capitalization); terms and conditions regarding penalties associated with payment delays for said financing instrument; terms and conditions regarding liabilities or indemnifications for said financing instrument; terms and conditions regarding resolution of legal disputes for said financing instrument; terms and conditions regarding repossession or foreclosure for said financing instrument; terms defining if the financing instrument is secured; terms defining how the financing instrument is secured; terms defining how costs shall be shared or borne by parties to the transaction; terms defining how returns, revenues, profits or other cash flows shall be shared or borne by parties to the transaction; or other financing terms known in the art that are used to particularly identify and establish a financing relationship between parties.

System

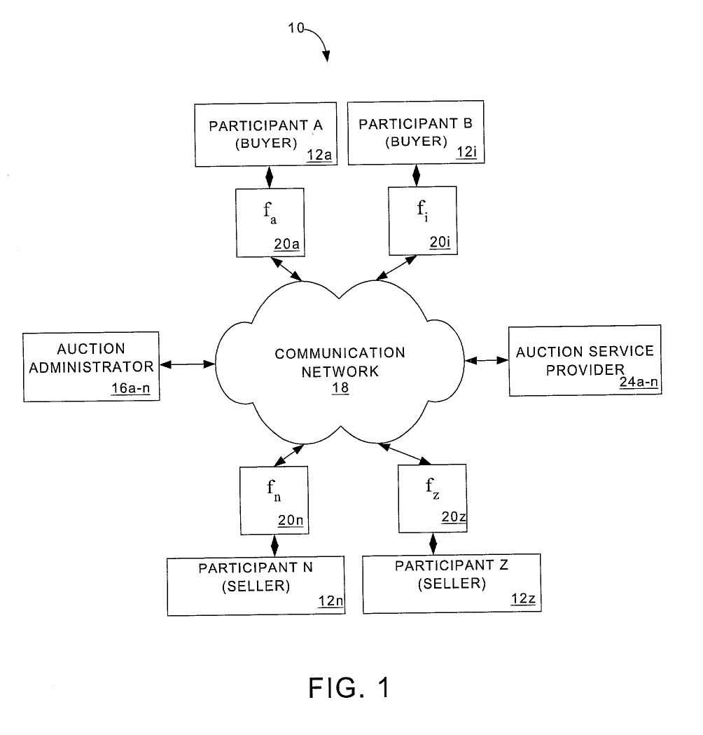

Referring first to FIG. 1, an auction system 10 according to embodiments of the present invention is shown. As shown in FIG. 1, auction system 10 includes a number of participants operating participant devices 12. The participants may include one or more individuals or entities acting as buyers in an auction (and operating buyer devices 12a-i) and who submit offers to purchase items posted for sale or purchase in the auction. The participants also include one or more individuals or entities acting as sellers in an auction (and operating seller devices 12n-z) and who submit offers to sell items in an auction. One or more auction administrators operating auction administrator devices 16a-n may be employed to administer auctions employing features of the present invention. One or more auction service providers operating auction service provider devices 24a-n may be employed to provide value-added services supporting an auction conducted in auction system 10.

Each of these parties may communicate and participate in auctions pursuant to the invention via a communication network 18. Each of the parties, in one embodiment, operates computing devices in communication with communication network 18. These devices will be described further below. For the purpose of describing features of the invention, the party (e.g., the auction administrator) and the device operated by that party (e.g., an auction administrator computing device) may be referred to as either the party or the device (e.g., “participant 12” may also be referred to as “participant device 12”).

In one embodiment of the present invention, an auction utilizing features of the present invention involves one auction administrator operating auction administrator device 16 that is configured as a Web-based server device accessible to participants 12a-z (including participants acting as buyers as well as participants acting as sellers) via the Internet. As will be described further below, the auction operated by the auction administrator via auction administrator device 16 may be any of a number of different types. Participation by buyers and sellers will vary based on the type of auction. For example, in a sell-side auction, a plurality of buyers operating buyer devices 12a-i will interact with an auction administrator operating auction administrator device 16 to submit offers to purchase items posted by one or more sellers operating seller devices 12n-z. In a buy-side auction, a plurality of seller devices 12n-z will interact with auction administrator device 16 to present offers to sell items requested by one or more buyers via buyer devices 12a-i. Other auction or exchange types will involve other forms of interaction known in the art.

Pursuant to one embodiment of the present invention, one or more participants may be associated with one or more customized financing terms which may be applied to bids, status requests, or other information exchanges via one or more financing functions 20. As described in co-pending, commonly-assigned U.S. patent application Ser. Nos. ______, ______, ______, ______ (Attorney Docket Nos. I01.050, I01.051, I01.052, and I01.053, referenced above) Applicants have developed auction techniques which utilize transformation functions to customize participation by a number of different participants in an auction. The techniques described in these co-pending applications may be utilized in conjunction with embodiments of the present invention as described herein. Financing functions 20, as will be described further below, are used to establish, define, adapt, modify, adapt, translate or otherwise transform financing information used in an auction.

As an example, a participant such as Participant A (Buyer 12a in FIG. 1) may have established an associated financing function 20a (e.g., this function may be established prior to or during the conduct of the auction) which transforms some or all of the bids submitted by Participant A by applying one or more financing terms to each bid. For example, financing function 20a may define lease terms that have been established by Participant A that apply to certain types of bids made by Participant A (e.g., Participant A may wish to lease certain types of capital equipment having a cost of greater than $100,000, and may desire that the lease be a 20 year lease with a down payment of 10% of the item cost). Other participants may have different financing functions associated with them. For example, Participant B (Buyer 12b in FIG. 1), acting as a buyer in the same auction as Participant A may be associated with a financing function 20b that automatically applies Participant B's desire to enter into a loan to purchase certain types of goods, over a particular term and at a particular rate.

Financing functions 20 may also be used to modify, adapt, translate or otherwise transform financing information that is transmitted from auction administrator device 16 to one or more participant devices 12. For example, after the auction status has been updated to reflect Participant B's bid (in the example above), Participant A may request information regarding the status of the auction. The status may be transformed using the financing function 20a established for Participant A to present the information in the context of Participant A's desired financing (i.e., in terms of Participant A's preferred leasing terms). These financing functions and their application will be described in more detail further below.

Each of the parties operating devices 12, 16 or 24 may communicate via communication network 18, which may be any of a number of different types of commonly-used networks, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology.

Although some embodiments of the present invention are described with respect to information exchanged using a Web site, according to other embodiments information can instead be exchanged, for example, via: a telephone, an Interactive Voice Response Unit (IVRU), electronic mail, a WEBTV®) interface, a cable network interface, and/or a wireless communication system.

Participant devices 12a-z, auction administrator devices 16a-n and auction service provider devices 24a-n may be any devices capable of performing the various functions described herein. In one embodiment, auction administrator devices 16a-n and auction service provider devices 24a-n are configured as Web-based server devices, and participant devices 12a-z are configured as general purpose computing devices. In general, participant devices 12, auction administrator devices 16 and auction service provider devices 24 may be computing devices such as: a Personal Computer (PC), a portable computing device such as a Personal Digital Assistant (PDA), a wired or wireless telephone, a one-way or two-way pager, a kiosk, an interactive television device, or any other appropriate storage and/or communication device.

Devices

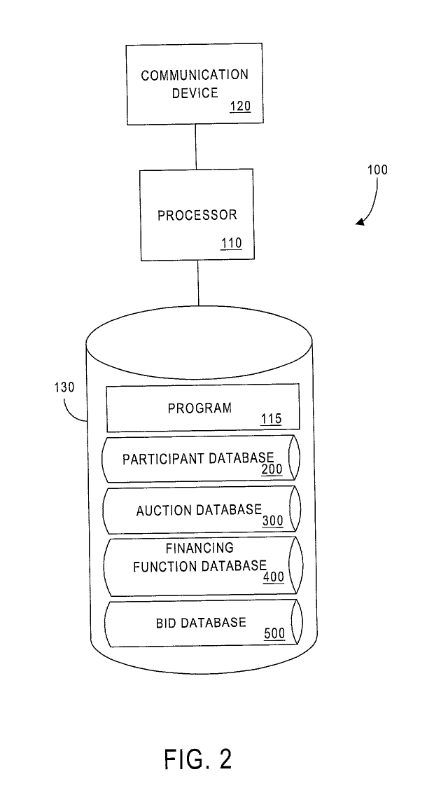

FIG. 2 illustrates an embodiment of an auction administrator device 100 which may be operated by an auction administrator in the system of FIG. 1. Auction administrator device 100 may be used in embodiments where an auction administrator is used to administer and conduct an auction pursuant to the invention. In other embodiments, a buyer, a seller, an auction service provider or other entity may participate in the administration of the auction.

Administrator device 100 may be implemented as a system controller, a dedicated hardware circuit, an appropriately programmed general purpose computer, or any other equivalent electronic, mechanical or electro-mechanical device. Administrator device 100 comprises a processor 110, which may be any of a number of suitable processing devices, such as one or more Intel® Pentium® processors. Processor 110 is coupled to a communication device 120 through which processor 110 communicates with other devices, such as, for example, one or more participant devices 12 operated by buyers and/or sellers participating in the auction, and auction service provider devices 24 operated by auction service providers providing value-added services in support of an auction (each of which devices may also be implemented as general purpose computer or other equivalent electronic, mechanical, or electro-mechanical device).

Communication device 120 may include hardware and software to facilitate communication with other devices using wired or wireless techniques, or a combination of different techniques. For example, communication device 120 may be one or more of: a network adapter, a modem, a Bluetooth device, etc. In one embodiment, communication device 120 facilitates communication with other devices over a network such as the Internet. Processor 110 may also be in communication with one or more input and output devices (not shown) as are known in the art (such as, for example, a keyboard, mouse, microphone, monitor, printer, etc.).

Processor 110 is also in communication with a data storage device 130. Data storage device 130 comprises an appropriate combination of magnetic, optical and/or semiconductor memory, and may include, for example, Random Access Memory (RAM), Read-Only Memory (ROM), a compact disc and/or a hard disk. Processor 110 and data storage device 130 may each be, for example: (i) located entirely within a single computer or other computing device; or (ii) connected to each other by a remote communication medium, such as a serial port cable, telephone line or radio frequency transceiver. In one embodiment, administrator device 100 may comprise one or more computers that are connected to a remote server computer for maintaining databases.

Data storage device 130 stores a program 115 for controlling processor 110. Processor 110 performs instructions of program 115, and thereby operates in accordance with the present invention, and particularly in accordance with the methods described in detail herein. Program 115 may be stored in a compressed, uncompiled and/or encrypted format. Program 115 furthermore includes program elements that may be necessary for allowing processor 110 to interface with computer peripheral devices, such as an operating system, a database management system and “device drivers”. Appropriate program elements are known to those skilled in the art, and need not be described in detail herein.

According to an embodiment of the present invention, the instructions of program 115 may be read into a main memory from another computer-readable medium, such as from a ROM to RAM. Execution of sequences of the instructions in program 115 causes processor 110 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

Data storage device 130 also stores (i) a participant database 200, (ii) an auction database 300, (iii) a financing function database 400, and (iv) a bid database 500. These databases are described in detail below and depicted with exemplary entries in the accompanying figures.

Databases

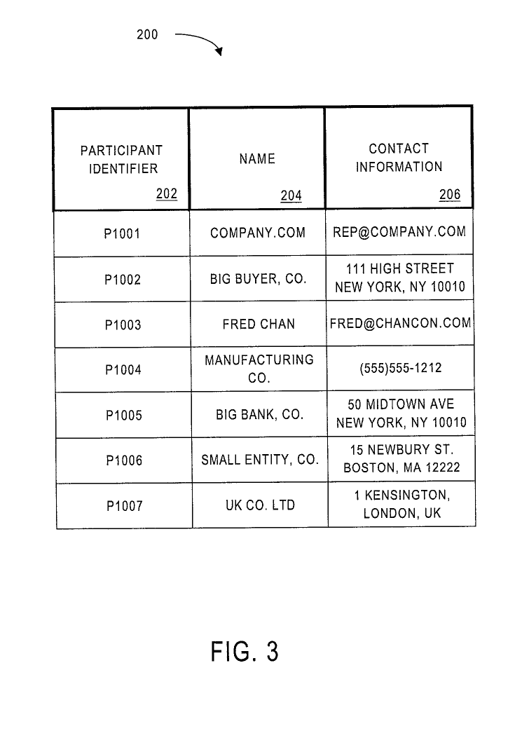

Each of the databases referred to in FIG. 2 will now be described by referring to FIGS. 3-6. While the databases are shown as being stored at, or accessible by, administrator device 100, portions of or all of the data in one or more of the databases may be stored at or accessible to other devices in the system. For example, in some embodiments, financing functions may be stored at (or accessible to) devices operated by other participants in an auction, such as devices operated by buyers, sellers, or service providers.

As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein.

Participant Database

Referring to FIG. 3, a table is shown representing a participant database 200 that may be stored at, or accessible by, auction administrator device 100 according to an embodiment of the present invention. The table includes entries identifying a number of different entities and/or individuals that have been identified as participating in an auction pursuant to the present invention. Participants identified in participant database 200 may include parties acting as buyers in an auction as well as parties acting as sellers in an auction. This information may be stored in database 200 when a participant registers for participation in one or more auctions.

The table shown in FIG. 3 defines a number of fields 202-206 for each of the entries. In the embodiment depicted, the fields specify: a participant identifier 202, a name 204, and contact information 206. Other fields and combinations of fields may also be used to provide and access information about different participants in an auction and their associated financing functions.

Participant identifier 202 may be, for example, an alphanumeric code or other information that is associated with and used to identify a participant who has registered to participate in one or more auctions pursuant to embodiments of the present invention. Participant identifier 202 may be generated by, for example, auction administrator device 100 (FIG. 2) or it may be provided by a participant. The participant's individual or company name may be provided in name 204, while information used to contact the participant may be provided in contact information 206.

In the table depicted in FIG. 3, participant information is stored in participant database 200, which is stored at or accessible by auction administrator device 100. In other embodiments, participant information (or some portion thereof), may be stored at other locations, such as a database stored at or accessible to participant device 12 or auction service provider device 24 (FIG. 1). In such embodiments, participant information may be requested from the device that is storing or has access to the information, or it may be requested by other devices in the system.

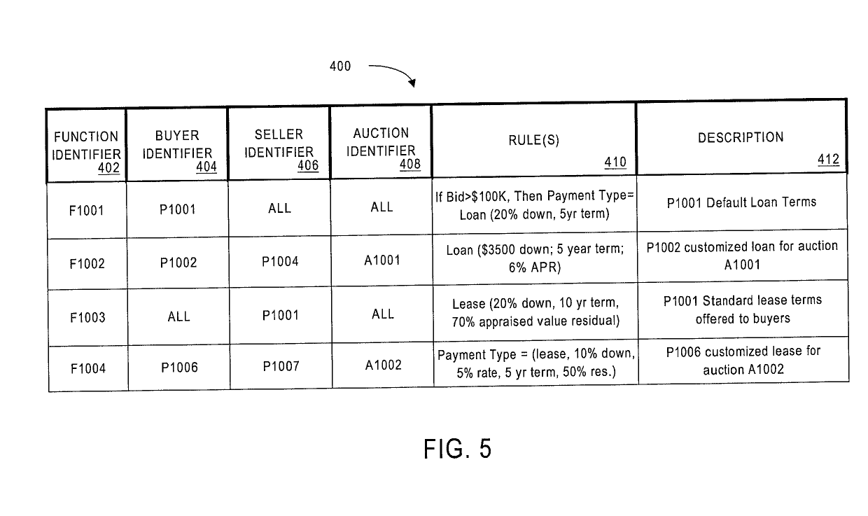

In some embodiments, further participant information may be specified to assist in the precise selection and identification of financing functions (which will be described further below in conjunction with FIG. 5). This information could include, for example, information that is useful (or necessary) in determining whether to authorize the establishment of a particular financing term for a particular participant. For example, information about a participant's credit history may be provided (e.g., such as a credit score from a so-called FICO score generated by credit scoring models licensed by Fair, Isaacs & Co) to allow a lender or financial institution to make an approval decision for a particular financing term. Those skilled in the art, upon reading this disclosure, will recognize that other information may also be provided which may allow the creation, selection, approval and application of appropriate financing functions for a particular participant.

Auction Database

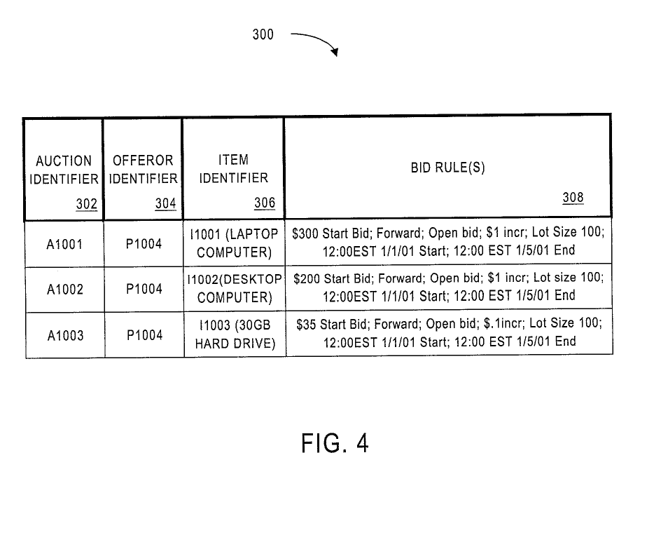

Referring now to FIG. 4, a table is shown representing an auction database 300 that may be stored at, or accessible to, auction administrator device 100 (FIG. 2) according to an embodiment of the present invention. The table includes a number of entries identifying one or more auctions that are operated by the auction administrator. The table also defines fields 302-308 for each of the entries. The fields specify information used to identify each of the auctions administered by the auction administrator, including for example: an auction identifier 302, a seller identifier 304, an item identifier 306, and one or more bid rule(s) 308. The information in auction database 300 may be created and updated, for example, when an auction administrator establishes an auction using features of embodiments of the present invention. This information may be entered by an auction administrator operating auction administrator device 100. In some embodiments, the information may also be entered by other parties, such as a participant operating participant device 12 or a service provider operating auction service provider device 24 (FIG. 1).

Auction identifier 302 may be, for example, an alphanumeric code associated with an auction administered by an auction administrator. Auction identifier 302 may be generated by, for example, auction administrator device 100.

Offeror identifier 304 may be, for example, the same as or related to participant identifier 202 of participant database 200. Offeror identifier 304 identifies the party in the auction identified by auction identifier 302 who is soliciting bids on an item. For example, in a sell-side auction, the offeror identifier 304 identifies a participant who has posted an item for sale via the auction identified by auction identifier 302. In a buy-side auction, on the other hand, the offeror identifier 304 identifies a participant interested in purchasing an item or items, and is soliciting bids from prospective sellers via the auction identified by auction identifier 302.

In some embodiments, offeror identifier 304 may identify an offeror that does not have a participant identifier (from participant database 200). In such cases, additional information identifying the offeror may be provided, for example, in auction database 300.

Item identifier 306 may be, for example, information identifying one or more items for which bids are being solicited in the auction identified by auction identifier 302. The information may include, for example, a product code such as a Universal Product Code (UPC) or other information particularly identifying the item(s). In the depicted embodiment, item identifier 306 simply includes an alphanumeric designator along with a brief description of the item. In other embodiments, further details of offered items may be specified to precisely identify items offered by auction. These details could include descriptions of product or service characteristics, images depicting a product or service, information about the manufacturer or provider of a product or service, information about delivery terms associated with a product or service, links to web pages with further information about the product or services, links to web pages with further information about the manufacturer or provider of a product or service, etc.

Bid rule(s) 308 may include information identifying one or more rules that govern the bidding process of the auction identified by auction identifier 302. For example, bid rule(s) 308 may include rules specifying a starting bid for the item, whether the auction is a forward or a reverse auction, whether the auction is public or private, whether bidding will be anonymous or not, the type of auction (e.g., open cry, sealed-bid, Dutch, English, etc.), a minimum bid increment, a start time, an end time, a reserve price, etc. In some cases, these rules may specify other databases or database fields with further information required to process the rule. For example, if a rule specifies that an auction is a private auction, it might include a reference to another database specifying qualified participants in the private auction. Other rules necessary to govern the conduct of the auction identified by auction identifier 302 may also be provided in bid rule(s) 308.

Financing Function Database

Referring to FIG. 5, a table represents a financing function database 400 that may be stored at (or accessible to) auction administrator device 100 (FIG. 2) according to an embodiment of the present invention. The table includes a number of entries identifying different financing functions that may be applied to information in auctions operated pursuant to embodiments of the present invention.

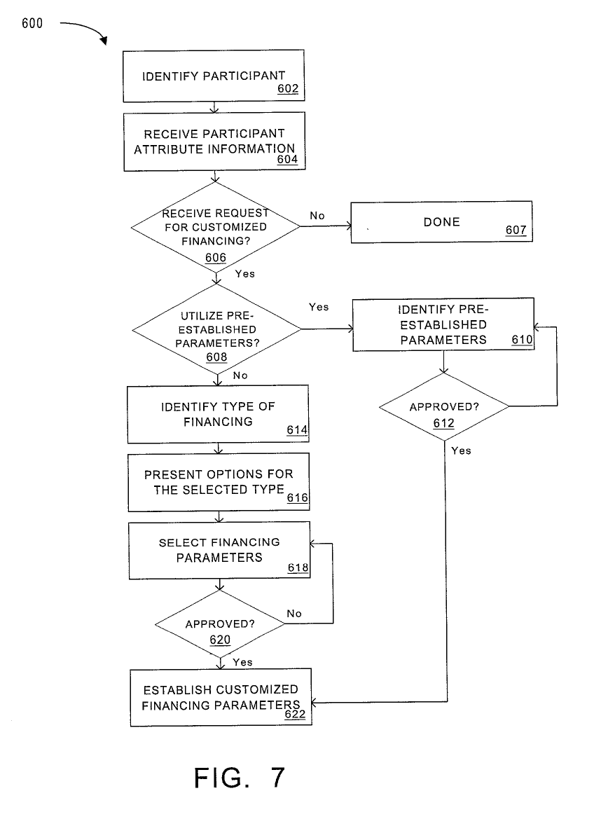

The table also defines a number of fields 402-412 for each of the entries. The fields specify: a function identifier 402, a buyer identifier 404, a seller identifier 406, an auction identifier 408, financing rule(s) 410, and a description 412. The information in financing function database 400 may be created and updated, for example, by an auction administrator based on information received from individual participants in an auction. In one embodiment, some or all of the information in financing function database 400 is generated and stored prior to commencement of an auction. In other embodiments, some or all of the information in financing function database 400 is generated and stored during an auction. In either embodiment, the process described below in conjunction with FIG. 7 may be used to develop, identify and generate financing functions.

Function identifier 402 may be, for example, an alphanumeric code associated with a particular financing function that may be used in an auction operated pursuant to embodiments of the present invention. A number of different function identifiers 402 may be established for use in an auction.

Buyer identifier 404 may be the same as or related to a participant identifier 202 from participant database 200 (FIG. 3) and is used to identify a particular participant in an auction who is acting as a buyer in the auction and who has established (or is establishing) one or more customized financing terms pursuant to embodiments of the present invention. In some embodiments, a particular financing function identified by function identifier 402 may apply to all buyers in an auction.

Seller identifier 406 may be the same as or related to a participant identifier 202 from participant database 200 (FIG. 3) and is used to identify a particular participant in an auction who is acting as a seller in the auction. The seller identifier may be identified based on information provided by the buyer while the buyer is establishing customized financing terms, or the seller may be automatically identified by the system based on information provided about the auction. In some embodiments, financing functions may be established independent of a particular seller (e.g., a buyer's financing function apply to all transactions by that participant, with any seller, and in any auction).

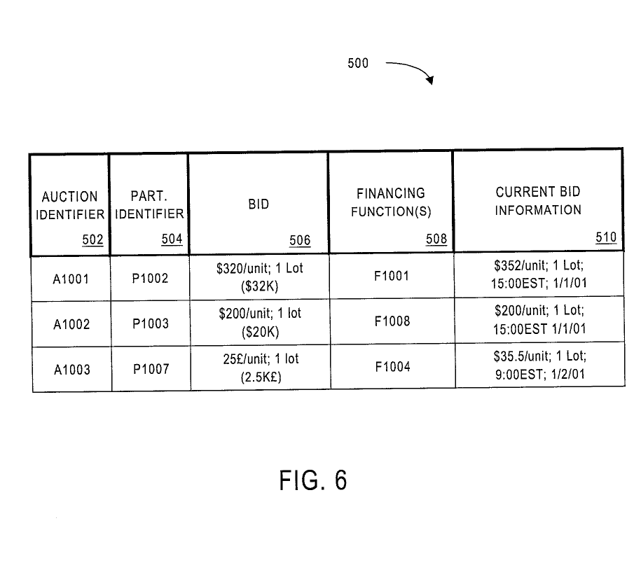

Auction identifier 408 may be the same as or related to an auction identifier 502 from auction database 500 (FIG. 6) and is used to identify a particular auction in which the participant identified by buyer identifier 404 is participating. In some embodiments, financing functions may be established independent of a particular auction (e.g., the buyer may establish customized financing terms which will apply to any auction in which the buyer participates). In other embodiments, the financing function identified by function identifier 402 may be established for a particular buyer only for use in a particular auction for items sold by a particular seller.

Financing function rule(s) 410 may be, for example, information identifying one or more rules that are applied when the financing function identified by function identifier 402 is used. Rule(s) 404 may include any of a number of different types of rules including rules that operate on a bid in an auction to define financing terms for the bid. In some embodiments, financing rules(s) 410 provide sufficient detail to fully define terms of a financing instrument to be used to acquire an item at auction. In other embodiments, financing rule(s) 410 specify certain customized terms desired by the buyer identified by buyer identifier 404. In some embodiments, financing rule(s) 410 are selected by the seller or other participants in the auction, alone or jointly.

For example, in some embodiments, financing rule(s) may be established which depend on the identity of the seller (e.g., the party offering to sell items via auction). In some embodiments, the seller may offer particular leasing or financing terms to buyers who purchase a certain dollar amount of items from the seller. These leasing terms may be identified and applied via rules contained in financing rule(s) 410.

As another example, in some embodiments, the application of a particular financing rule will depend on the identity of both the seller (e.g., the party offering to sell items via auction) and the buyer (e.g., the party offering to buy items via auction). For example, in some embodiments, the seller may offer preferential loan terms to particular buyers with which the seller has a long-standing relationship. This preferential status may be identified and applied via rules contained in financing rule(s) 410.

As another example, in some embodiments, the application of a particular financing rule will depend on the identity of both the seller (e.g., the party offering to sell items via auction) and the nature or identity of the item posted for sale or purchase via the auction. For example, in some embodiments, the seller may offer particular financing terms only on selected items, selected sets of items, or selected classes of items. This preferential status may be identified and applied via rules contained in financing rule(s) 410.

In one embodiment, financing rule(s) 410 are established prior to the conduct of an auction. In other embodiments, financing rule(s) 410 are established during the conduct of an auction. In either embodiment, a selection process, such as the process described below in conjunction with FIG. 7 may be used to establish the rules.

In general, financing rule(s) 410 define the financing terms associated with the particular financing arrangement associated with the sale or purchase of an item via the auction. Different types of financing instruments may include one or more financing terms such as a financing price, a term of the financing instrument, or other terms as described above.

In certain embodiments, auction service provider 24 (FIG. 1) may provide services to facilitate the provision of a lease, loan, or other financing arrangement. In these embodiments, additional information is stored in financing function database 400 or in a related database, including the identity of the auction service provider, the services provided, and any rules or terms associated with the services. For example, a bank might provide financing for a transaction between a buyer and a seller in an auction comprising a loan with a $500 down payment, monthly payments, a 5 year term, and an annual simple interest rate of 10%. In one embodiment of the present invention, this information would be stored using an entry in financing function database 400 identifying the bank, probably using an additional field. Rule(s) 410 would then specify the terms associated with the loan.

Bid Database

Referring now to FIG. 6, a table is shown which represents a bid database 500 that may be stored at, or accessible by, auction administrator device 100 according to an embodiment of the present invention. The table includes a number of entries identifying bids that have been received in auctions administered by an auction administrator operating auction administrator device 100. For clarity of exposition, only a few exemplary bids are illustrated in the table shown in FIG. 6. As described in the definitions set forth above, “bids” as used herein may refer to either offers to purchase or offers to sell (depending on the type of auction operated), therefore, bid database 500 may record information about offers to sell (e.g., in the case of a buy-side auction), offers to purchase (e.g., in the case of a sell-side auction), or both offers to purchase and offers to sell (e.g., in the case of a two-sided auction).

The table also defines a number of fields 502-510 for each of the entries. The fields specify: an auction identifier 502, a participant identifier 504, a bid 506, a financing function(s) 508, and current bid information 510. The information in bid database 500 may be created and updated, for example, each time auction administrator 16 receives a bid from a participant in an auction being operated by auction administrator 16. Some or all of the information stored in bid database 500 may be received via communication network 18 in any of a number of different formats. For example, bids (and other information transmitted pursuant to the invention) may be submitted by (or to) participants 12 via electronic data interchange (EDI) messages, via Extensible Markup Language (XML) messages, via instant messaging, via electronic mail, via Web-based forms, via telephone or facsimile, telex, etc.

Auction identifier 502 may be, for example, based on or identical to auction identifier 302 of auction database 300, and is used to associate a particular bid with a particular auction. Each auction identified by an auction identifier 502 may have a number of entries representing individual bids received for that auction. In the table shown in FIG. 6, only the current best bid in each auction is shown. However, other bids and offers, including a previous best bid or bids, or current bids that are not the current best bid, could also be recorded in bid database 500. For example, in a continuous two-sided auction, a buyer may place a bid that at the time of the bid may not be the current best bid, but which may become the current best bid as market conditions change over time.

Participant identifier 504 may be, for example, based on or identical to a participant identifier 202 of participant database 200 and is used to identify a particular participant (such as a buyer or seller) in an auction. Each participant in an auction may submit multiple bids and, therefore, bid database 500 may contain multiple entries for a participant in a particular auction. In the example data depicted in FIG. 6, bid data is shown for three different participants (buyers P1002, P1003, and P1007) bidding in three different auctions (auctions A1001, A1002 and A1003).

Bid 506, may be, for example, information identifying a particular bid made by a participating buyer or seller. In the embodiment depicted, only information reflecting the current best bid in each auction is depicted. In some embodiments, data will also be stored indicating the bid history of the auction, including all bids received (whether or not a bid is the current best bid or not). The information in bid 506, in one embodiment, reflects non-transformed bid information. For example, referring to the first row of the table shown in FIG. 6, bid 506 made by participant P1002 is a bid to purchase one (1) lot of the item being auction in auction A1001 (reference to auction database 400 shows that item I1001—laptop computers—are the items being auctioned) at a bid price of $320/unit.

In some embodiments, there may be more than one current best bid or offer for each auction. For example, in some auctions, a single lot containing multiple items may be offered to multiple buyers. Bid database 500 may also be used to record former current best bids to provide a bid history or audit trail. For example, this information may be used to track the bidding history of different buyers and/or to award units being sold in the auction to a substitute buyer in the case where a current best buyer (or group of current best buyers) is unable to settle their auction trade. In some embodiments, bid database 500 may also be used to record current bids that are not the best bid.

Financing function(s) 508 may be the same as, or related to, one or more financing functions identified by function identifier 402 from financing database 400 (FIG. 5). Financing function(s) 508 specify one or more financing functions which will be applied to the participant's bid if the bid is accepted and bound in the auction (e.g., if the participant's bid is accepted by the seller). For example, if participant P1002's bid in auction A1001 is accepted, the Laptop Computers will be purchased by participant P1002 using the financing terms established and identified by financing function identifier F1001.

Current bid information 510, may be, for example, information identifying the current best bid in a particular auction. In a forward sell-side auction, the current best bid is the highest offer received. The best bid in a buy-side auction may be the lowest price offered for an item. Current bid information 510, may be, for example, information identifying a current status of the auction identified by auction identifier 502. The nature and content of this information may depend on the type of auction. For example, in a typical Open cry, forward, sell-side auction, current bid information 510 may include a current high bid amount and a current high bid quantity.

Other information necessary or useful in identifying a current bid status may also be provided in current bid information 510 (e.g., the time of the current bid may also be provided). In one embodiment, this current bid information 510 represents the current bid status at a particular moment in time (e.g., upon receipt and processing of the current bid received by the participant identified by participant identifier 504 in the auction identified by auction identifier 502).

In the data shown in FIG. 6, current bid information 510 reflects the current best bid in the auction. This current bid information 510 may be provided to participants to reflect the current status of the auction (e.g., informing potential participants of the current best bid). In some embodiments, current bid information 510 may be transformed before it is communicated to certain participants. For example, financing function(s) 508 may be used to transform bid information for viewing in response to an auction status request. For example, a status request for status in auction A1001 may be transformed to indicate that the current bid is a bid to purchase 1 Lot of the item at $352/unit by participant P1002 in a financing arrangement that is specified by financing function F1001. Other transformations may also be associated with a particular bid (or a request for status of a bid), as described in co-pending U.S. patent application Ser. Nos. ______, ______, ______, ______ (Attorney Docket Nos. I01.050, I01.051, I01.052 and I01.053 referenced above).

Those skilled in the art will recognize that other types of data may be included in bid database 500. For example, other types of information may be required in different types of auctions. A two-sided auction may require tracking limit orders and may also require tracking the expiration date and time of the limit orders. A two-sided auction may also require differentiated offers to buy from offers to sell. Other types of auctions may allow submission (and thus require tracking) of bids that are contingent on the occurrence or non-occurrence of some event. Other systems architectures are possible as well. For example, to improve system response times, historical bid information may be stored in a separate database.

Process

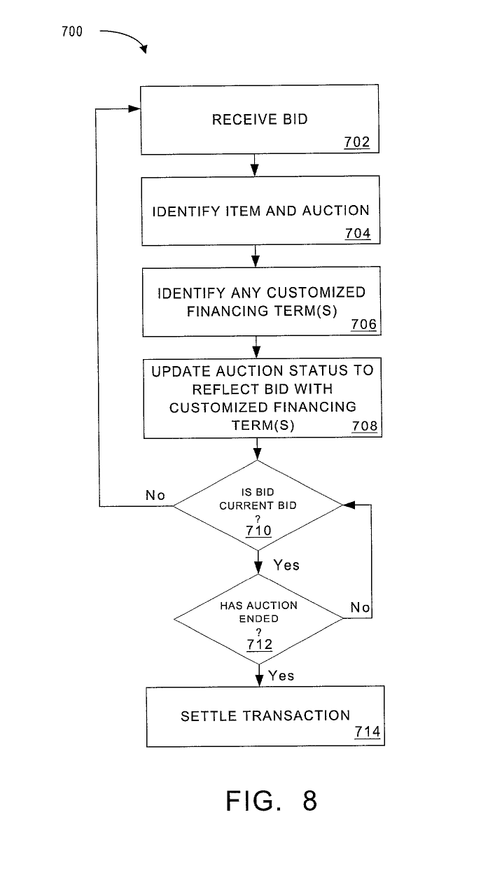

Processes pursuant to embodiments of the present invention will now be described by referring to FIGS. 7-8. In particular, a process for establishing customized financing terms and a bid process will be described. In one embodiment, the processes described in FIGS. 7-8 are conducted under the direction of computer program code stored at auction administrator device 16, participant device 12 and/or auction service provider device 24 (or any combination thereof). The particular arrangements of elements in the flow charts of FIGS. 7-8 are not meant to imply a fixed order to the steps; embodiments of the present invention can be practiced in any order that is practicable.

Referring now to FIG. 7, a process 600 for establishing customized financing terms pursuant to one embodiment of the present invention is shown. Process 600 may be performed using devices of system 100 (FIG. 1) so that the participant may establish customized financing terms using features of the present invention. As an example, process 600 is a process conducted for a prospective buyer in one or more auctions, involving interaction between the buyer operating buyer device 12a-i and an auction administrator operating auction administrator device 16 via a communication network 18 such as the Internet, resulting in the establishment of one or more customized financing terms for the buyer. As another example, process 600 is a process for a prospective seller in one or more auctions, involving interaction between the seller operating seller device 12n-z and an auction administrator operating auction administrator device 16, resulting in the establishment of one or more customized financing terms for the seller. Other customized financing terms may be established jointly by buyers and sellers.

In some embodiments process 600 occurs during a participant registration process or otherwise prior to the conduct of an auction in which the customized financing terms will be used. In other embodiments, process 600 is conducted in conjunction with a bidding process (e.g., such as the process described below in conjunction with FIG. 8) to establish customized financing terms for a particular bid. In some instances, such financing functions may apply only to a single auction, while in other instances such financing functions may be utilized in multiple auctions. In some embodiments, process 600 may establish financing functions that apply to groups or classes of participants, rather than individual participants. In some embodiments, functions established by process 600 apply to all bids made by a participant. In other embodiments, process 600 establishes one or more financing functions intended for use with one or more particular bids by a participant or set of participants.

In some embodiments, the terms of the financing instrument may be binding on one or more auction participants. For example, one or more auction participants may agree to the terms prior to participating in a winning bid or offer, and their participation in the winning bid constitutes a binding commitment to abide by the terms of the financing instrument. In other embodiments, the auction participants may have the right but not the obligation to enter into the financing agreement specified during the registration process or otherwise prior to or during the conduct of an auction. In other embodiments, the financing arrangement may be offered on a “best efforts” basis, and success in the auction may not constitute a binding commitment to provide or to enter into a financing arrangement. In some embodiments, information about financing arrangement bindings will be presented to (or by) one or more parties to a financing arrangement, or to (or by) entities facilitating a financing arrangement.

Process 600 begins at 602 where the participant is identified. This identification may involve the participant providing information used to populate, for example, participant database 200 (FIG. 3). For example, processing at 602 may involve prompting the participant to enter basic information, including contact information, a participant name, a participant identifier, etc.

The participant may be identified by any of a number of other techniques as well. For example, a participant interacting via e-mail may be identified by its e-mail address. A participant interacting via a Web-site may be identified by a user name, and the participant's identity may be authenticated using a password verification process. Participants may also be identified by an identification number, such as an account number, a credit or debit card number, or a social security number. For XML and EDI transactions, the participant could be identified by fields located within XML or EDI messages. Participants interacting via facsimile or telephone may be identified using information about the originating telephone number. Participants could also be identified using cookies stored on a participant device 12.

Once the participant has been identified at 602, processing continues at 604 where participant attribute information is received. This attribute information is used to generate, select, or otherwise establish financing function(s) for the participant. Participant attribute information may include any information useful or necessary to establish one or more customized financing terms for the participant. For example, information received at 604 may include: a preferred currency of the participant; information specifying whether the participant has a particular relationship with one or more other participants (e.g., as a preferred customer of one or more sellers, etc.); information specifying a credit history of the participant, information specifying a particular type of preferred financing, information specifying a particular lender or financial institution preferred by the participant; etc.

In one embodiment, this information may be solicited using a series of questions that are presented to the participant for response. For example, in embodiments where the participant is operating a participant device and interacting with auction administrator device via the Internet, this information may be solicited by presenting the participant with a set of forms for entry and/or a checklist of options that may be selected by the participant. Other methods of soliciting and collecting information may also be used to establish financing function(s). For example, third party databases may be accessed to collect some information. Such third party databases may include, for example: credit service bureaus, banks, rating agencies, insurance companies, medical agencies, check processing agencies, advertising agencies, motor vehicle departments, census bureaus, credit card agencies, governmental bodies, non-governmental organizations, non-profit organizations, or the like.

Processing at 604 may be performed in conjunction with one or more transformation binding processes as described in co-pending U.S. patent application Ser. Nos. ______, ______, ______, ______ (Attorney Docket Nos. I01.050, I01.051, I01.052 and I01.053 referenced above).

Once attribute information has been received at 604, processing continues to 606 where determination is made whether a request for customized financing has been received. If the participant has not chosen to establish customized financing terms, processing terminates at 607 (e.g., the auction may progress in a typical fashion without customized financing). If the participant has chosen to establish customized financing terms, processing continues at 608 where a determination is made whether the one or more pre-established terms may be utilized. For example, in one embodiment, a number of financing functions may have been previously established and stored in financing function database 400 (FIG. 5). Processing at 608 operates to determine if the participant identified at 602 wishes to utilize any of these previously-established terms. If the participant so desires, processing continues at 610 where the pre-established terms are identified. For example, this may involve performing a look-up of database 400 to determine which pre-established terms apply to the participant.

In some embodiments, a determination may be made at 612 whether the pre-established terms identified at 610 are approved for use by the participant identified at 602. This approval determination may include, for example, a credit approval, an approval of the seller, or the like. Once the pre-established terms are identified and approved processing continues to 622 where the terms are established as the participant's customized financing terms.

In some embodiments, no pre-established terms will be available for a particular participant, or the participant may choose not to utilize the pre-established terms. In such a situation, processing will proceed from 608 to 614 where the participant, operating a participant device 12, will interact with other devices in system 100 to identify a type of financing desired. For example, the participant may be given the choice to select either a loan or a lease as a type of financing instrument.

In some embodiments, identifying a type of financing may require interactions with other participant devices (e.g. in the case where a seller is providing a loan or a lease to buyer), an auction administrator (e.g. in the case where the auction administrator is offering financing as a value-added service in an exchange, marketplace, or collaboration network), or an auction service provider (e.g. in the case where a financial services entity acting as an auction service provider offers third-party financing as a value-added service in an exchange, marketplace, or collaboration network). In some embodiments, identifying a type of financing may require interactions with a combination of multiple devices in system 100. For example, an auction participant may be presented a menu of financing types provided by different entities, including auction participants, auction administrators, and auction service providers. In some embodiments, individual financing choices may require interactions with a combination of multiple devices in system 100. For example, a certain type of financing may require the participation of a bank to provide financing, a leasing service provider to manage a lease, an insurance company to provide insurance on the item being transacted at auction, and a manufacturer who agrees to repurchase the item being transacted at auction for a specified residual value.

Once a type of financing has been selected, processing continues at 616 where one or more options for the selected financing type are presented to the participant. For example, if a loan is selected, the participant may be presented with options such as: the term of the loan, the lender, the price (e.g., interest charged) for the loan, the down payment required, etc. If a lease is selected, the participant may be presented with lease options, such as: the term of the lease, the lessor, the price (e.g., up front fees and lease fees), the down payment required, the residual value of the item leased, etc. In embodiments where process 600 is conducted during an auction (e.g., when the item for sale and the seller are known), some or all of the options presented at 616 may be tailored to the auction. For example, if a lease has been selected, one or more residual values of the item may be calculated by system 100 and presented to the participant at 616. Processing at 616 may entail reference to one or more external sources of data. For example, the residual value of an item may be referenced by consulting a source of residual data for the item. As another example, various prices of loans may be determined by reference to current rate information from a prospective lender.

In some embodiments, processing at 616 may involve interactions with one or more auction participants, auction administrators, or auction service providers. In some embodiments, presenting options for the selected type of financing may require interactions with other participant devices (e.g. in the case where a seller is providing a loan or a lease to buyer), an auction administrator (e.g. in the case where the auction administrator is offering financing as a value-added service in an exchange, marketplace, or collaboration network), or an auction service provider (e.g. in the case where a financial services entity acting as an auction service provider offers third-party financing as a value-added service in an exchange, marketplace, or collaboration network). In some embodiments, presenting options for the selected type of financing may require interactions with a combination of multiple devices in system 100. For example, an auction participant may be presented a menu of financing options provided by different entities, including auction participants, auction administrators, and auction service providers. In some embodiments, individual financing choices may require interactions with a combination of multiple devices in system 100. For example, a certain financing instrument may require the participation of a bank to provide financing, a leasing service provider to manage a lease, an insurance company to provide insurance on the item being transacted at auction, and a manufacturer who agrees to repurchase the item being transacted at auction for a specified residual value.

Upon presentation of available options, the participant is given the ability to select financing terms at 618. As discussed in reference to steps 614 and 616, in some embodiments, processing at 618 may involve interactions with one or more auction participants, auction administrators, or auction service providers. These options may be presented to the participant for selection in an iterative fashion at 616 and 618, or in some embodiments 614, 616 and 618, until each desired term has been customized by the participant.

Processing continues at 620 where a determination is made whether the financing terms selected by the participant are approved. For example, this may entail performing a loan or a lease analysis (as is known in the art) to arrive at an approval or decline for the particular financing terms selected by the participant. If the financing terms are declined, processing reverts to 618 where the participant may be given the chance to select other financing terms. If processing at 620 indicates that the selected financing terms are approved, processing continues at 622 where the selected and approved terms are established as the participant's customized financing terms. In one embodiment, the established terms are assigned a function identifier 402 and associated with the participant and stored in financing function database 400 (FIG. 5). In some embodiments, only pre-approved types of financing, financing options, and financing terms are presented to the participant at one or more of steps 614, 616 and 618. In cases where it is not necessary to make a determination at step 620 as to whether the financing terms selected by the participant are approved, processing continues via step 620 directly to step 622 without initiating an approval process.

According to embodiments of the invention, process 600 may be performed a number of times prior to or during an auction. The result is a system that allows personalization of bids (including offers to purchase and offers to sell) with customized financing terms, and the presentation of auction status information based on each participant's particular financing situation. As a result, differently-situated participants may take part in a single auction, allowing each participant to establish and apply customized financing terms in the auction.

A bid process 700 incorporating features of embodiments of the present invention will now be described by referring to FIG. 8. In one embodiment, bid process 700 is performed after an auction has been established for one or more items. In one embodiment, a participant may establish one or more customized financing terms prior to commencement of the auction by following the process 600 described above. In other embodiments, participants may establish one or more customized financing terms during the course of the auction by following the process 600 after submission of a bid (e.g., in conjunction with process 700 which will now be described). In one embodiment, bid process 700 is conducted under the direction of auction administrator device 16. In other embodiments, bid process 700 is conducted under the direction of an auction participant device 12 or an auction service provider device 24. In other embodiments, bid process 700 is conducted under the direction of one or more of an auction administrator device 16, an auction participant device 12 and an auction service provider device 24.

Processing begins at 702 where a bid is received. In one embodiment, the bid is received by auction administrator device 16 from a buyer operating buyer device 12a-i. Typically, the bid is received from the buyer after the buyer has had the opportunity to view the terms and conditions of the auction and read a description of the item(s) being offered in the auction. Further, unless the auction is of the sealed bid type or multiple-unit type, the buyer has also typically determined that it is willing to beat the current best bid on the item. In one embodiment, buyer device 12a-i transmits the bid to auction administrator device 16 over a network such as the Internet. Further, in one embodiment, the buyer views information about the auction by directing a Web-browser to an Internet site maintaining information about the auction.

The bid received at 702 may include information identifying the particular auction in which the bid is made, as well as information identifying the item bid on. The bid also typically includes terms of the bid such as a price term, and a quantity term, but in some embodiments it may also include a configuration term, a delivery term, and other terms particular to an item being auctioned, an auction participant, or services required by an auction participant.

Processing continues at 704, where the item bid on and the relevant auction are identified, e.g., using information received at 702 or by other means. Processing continues at 706 where any customized financing term(s) associated with the bid received at 702 are identified. In one embodiment, one or more financing functions specifying particular customized financing terms are identified by auction administrator device 16 (e.g., by retrieving information contained in, for example, participant database 200, and/or financing function database 400). A number of different techniques may be used to identify one or more financing functions associated with a bid. Financing functions may be identified based on: an identity of the buyer, an identity of the seller (or a relationship between the seller and the buyer), information about the seller, information about the item, information about the status of the auction, information about prices for comparable items in other markets, bidding history in the current auction, bidding histories in other auctions, and/or characteristics of the bid.

In some embodiments, bids or buyers (or sellers) may be associated with multiple financing functions. In such cases, the financing function(s) to be applied may be identified based in part on the other specified financing function(s). For example, a buyer may have one financing function which identifies that the buyer's preference in certain auctions is to lease items purchased. Another financing function may be associated with the buyer which establishes particular lease terms for particular types of items. Thus, the first function (identifying leasing as a preference) may be identified and applied before the second function (identifying particular lease terms).

In some embodiments, processing at 706 may involve checking multiple sources to identify relevant financing function(s). For example, processing at 706 may simply involve a search for financing functions accessible to auction administrator device 16, or it may involve a search for financing functions at auction administrator device 16, participant device 12 and/or auction service provider device 24. Other sources of financing functions may also be provided.

Once any relevant financing functions and associated customized financing term(s) have been identified at 706, processing continues at 708 where the auction status is updated to reflect the bid with customized financing term(s). In particular, this status update may involve applying one or more financing functions to the bid received at 702. In some embodiments, applying one or more financing functions may require reference to extrinsic data. For example, a financing function which requires identification of the current lease rate offered by a particular financial institution may require reference to a data source maintained by that financial institution. This reference may be performed in conjunction with processing at 708. In some embodiments, other participants in the auction may view the status of the auction by submitting a status request or other inquiry. In some embodiments of the present invention, a participant viewing the status of the auction may be presented with a status which has been modified by one or more financing functions associated with the participant. For example, a bidder who has established a leasing preference for a particular item in an auction who asks to view the current status of the auction will be presented with an auction status in terms of his leasing preference.

Processing continues at 710 where a determination is made whether the bid received at 702, along with any customized financing term(s) identified at 706, is the current best bid of the auction (e.g., the bid which would “win” the auction if the auction were to close with no further bids). The current best bid is determined based on the type of auction and the rules of the auction. In some embodiments, processing at 710 may include comparison of the bid received at 702 with previously received bids which were submitted with one or more financing terms. In some embodiments, the different bids compared at 710 may be compared based on the amount of the bid as well as the financing terms associated with each bid. For example, a seller may establish rules for an auction which indicate that a bidder making a cash bid will be preferred to a bidder submitting a bid involving a lease of the item offered in the auction. As another example, a seller may establish auction rules that indicate that a bid involving a lease will be preferred to a bid involving a loan. Other rules and comparisons may be established to select a best bid between bids that specify one or more customized financing terms.

If processing at 710 indicates that the bid is not the current best bid, processing reverts to 702 where the system awaits the next bid. If processing at 710 indicates that the bid is the current best bid, processing continues at 712 where a determination is made whether the auction has ended. If the auction has ended, the current best bid is the winning bid and processing continues at 714 where the transaction is settled (e.g., by applying the customized financing term(s) identified at 706). If processing at 712 indicates that the auction is ongoing, processing awaits a current best bid at the close of the auction.

In some embodiments, the terms of the financing instrument may be binding on one or more auction participants. In these embodiments, if the bid is identified as the winning bid or one of multiple winning bids, the customized financing terms which were established and applied using techniques of embodiments of the present invention are used to consummate the transaction (that is, if the customized financing terms establish and identify a particular lease as the preferred financing, the customized lease terms may be used to bind the buyer in the auction).

In other embodiments, the terms of the financing instrument may not be binding on one or more auction participants. In other embodiments, the terms of the financing instrument may be binding only on certain parties to the financing arrangement. For example, in certain embodiments, an auction participant may have the right but not the obligation to enter into a financing agreement specified during the registration process or otherwise prior to or during the conduct of an auction, while the provider of a financing agreement may be bound to enter into the agreement at the participant's option. In other embodiments, the terms of the financing arrangement may be binding only on an auction participant 12 identified as winning the auction, and not on the provider of the financing. For example, a financing arrangement may be offered by an auction service provider 24 on a “best efforts” basis, and said offer may not constitute a binding commitment to provide or to enter into the offered financing arrangement.

Although the present invention has been described with respect to a preferred embodiment thereof, those skilled in the art will note that various substitutions may be made to those embodiments described herein without departing from the spirit and scope of the present invention. The particular financing functions specified and described herein have been selected for clarity of exposition, and do not represent all possible customized financing functions which may be established and used pursuant to the invention. The stage at the auction process during which financing functions are associated or bound with a bid or buyer or seller submitting the bid, or other entity as specified and described herein have been selected for clarity of exposition, and do not represent all possible auction stages when financing functions could be associated or bound.

What is claimed is:

1. A method for facilitating the sale of an item in an auction involving a plurality of participants, comprising:
identifying a bid for said item;
identifying a financing function associated with said bid;
applying said financing function to said bid to generate a transformed bid reflecting customized financing terms; and
updating a state of said auction based on said financial function.

2. The method of claim 1, wherein said financing function includes at least a first parameter identifying a type of financing instrument.

3. The method of claim 2, wherein said type of financing instrument is at least one of a lease or a loan.

4. The method of claim 1, wherein said financing function includes information identifying at least one financing term.

5. The method of claim 1, wherein said identifying a financing function further comprises:
receiving a request to establish a financing function;
identifying a type of said financing function;
identifying at least a first term of said financing function; and
associating said financing function with said participant.

6. The method of claim 1, wherein said identifying a financing function further comprises:
searching a plurality of pre-established financing functions.

7. The method of claim 5, wherein said identifying a type of said financing function includes presenting a listing of available types to said participant for selection.

8. The method of claim 5, wherein said identifying at least a first term of said financing function includes presenting a listing of available terms to said participant for selection.

9. A method for establishing customized financing terms for use in an auction, comprising:
identifying a participant in said auction;
receiving a request from said participant to establish customized financing terms;
identifying a type of a financing instrument;
identifying at least a first term of said financing instrument to establish said customized financing terms; and
associating said customized financing terms with said participant for use in said auction.

10. The method of claim 9, further comprising:
receiving a bid on an item from said participant in said auction; and
applying said customized financing terms to said bid.

11. The method of claim 9, further comprising:
receiving a request for a status of said auction from said participant;
applying said customized financing terms to said status of said auction to generate a transformed status; and
presenting said transformed status of said auction to said participant.

12. The method of claim 9, wherein said identifying at least a first term of said financing instrument depends at least in part on a credit rating of said participant.

13. The method of claim 9, wherein said at least first term is a default term for said type of financing instrument.

14. A method for conducting an auction, comprising:
receiving a bid;
identifying an item and an auction based at least in part on said bid;
identifying at least a first customized financing term associated with said bid; and
updating a status of said auction to reflect said bid and said at least first customized financing term.

15. The method of claim 14, further comprising:
determining if said bid is a winning bid of said auction; and
settling said auction based on said at least first customized financing term.

16. The method of claim 14, further comprising:
identifying a type of financing instrument based at least in part on said bid.

17. The method of claim 14, wherein said determining includes:
comparing said bid with a second bid to identify a best bid.

18. The method of claim 17, wherein said comparing further comprises comparing said at least first customized financing term of said bid with at least a first customized financing term of said second bid.

19. A system for facilitating the sale of an item in an auction involving a plurality of participants, comprising:
means for identifying a bid for said item;
means for identifying a financing function associated with said participant; and
means for applying said financing function to said bid to generate a transformed bid reflecting customized financing terms.

20. An apparatus for facilitating the sale of an item in an auction involving a plurality of participants, comprising:
(a) a processor;
(b) a communications device, in communication with said processor, receiving bid data from a participant; and
(c) a memory unit in communication with the processor and storing a program, wherein the processor is operative with the program to
identify a financing function associated with said participant;
apply said financing function to said bid data to generate transformed bid data reflecting customized financing terms.

21. A computer-readable medium having computer-executable instructions for performing steps comprising:
receiving a bid;
identifying an item and an auction based at least in part on said bid;
identifying at least a first customized financing term associated with said bid;
updating a status of said auction to reflect said bid and said at least first customized financing term;
determining if said bid is a winning bid of said auction; and
settling said auction based on said at least first customized financing term.
